(19) United States
(12) Patent Application Publication
(10) Pub. No.: US 2006/0101469 A1
(43) Pub. Date: May 11, 2006

(54) Method, controller, program product and services for managing resource element queues

(75) Inventor: Roger G. Hathorn, Tucson, AZ (US)

Correspondence Address: LAW OFFICE OF DAN SHIFRIN, PC - IBM, 14081 WEST 59TH AVENUE, ARVADA, CO, 80004, US

(73) Assignee: International Business Machines (IBM) Corporation, Armonk, NY (US)

(21) Appl. No.: 10/986,486

(22) Filed: Nov. 10, 2004

(51) Int. Cl. G06F 9/46

(52) U.S. Cl. 718/104

(57) ABSTRACT

A method, controller, program product and service are provided for more efficiently managing a resource queue. Two or more queues are configured to handle workloads of various sizes. Resource elements are allocated from the top of each queue and returned to the bottom. The size of each queue may be selected to provide sufficient resource elements to handle a system's various levels of workload. As the workload increases and all of the resource elements in the one queue are allocated, new resource elements are allocated from the top of the next queue and returned to the bottom. When the workload decreases, resource elements are no longer allocated from the queues used for higher workloads. Thus, retention of historical data in the queues is enhanced while efficient cache utilization is maintained.

### TECHNICAL FIELD

The present invention relates generally to resource element queues in computer systems and, in particular, to managing such queues to improve data capture for problem determination while reducing adverse effects to cache performance.

### BACKGROUND ART

Many customers of large scale computer systems require that the systems have a high availability. Therefore, it is important that the state of a system be monitored to aid the resolution of crashes, failures or other problems. One method for reviewing the current and immediate past states of a system is to examine the contents of data structures upon the occurrence of significant adverse events.

In the normal course of operations, space in a system's memory is assigned to a pool of data structures, known generally as allocation units or resource elements, which direct the performance of various types of task. The structures include, but are not limited to, task control blocks and DMA control blocks. The memory pool is configured as a list or queue containing space for a specified number of resource elements. When a task request is received by the processor, a queue controller allocates a resource element from the top of the queue to the data structure. Data (instructions, system state information and other data) is copied to cache memory for processing if the data is not already present from prior use. When the task is completed, the resource element is freed and returned to the queue for subsequent reuse. If the memory assigned to the queue is insufficient, there will be insufficient resource elements available to handle as many concurrently active elements as are required by the system workload. If the size of the queue becomes very large, however, a large amount of data is cycled through the processor cache causing poor cache utilization: by the time an element is reallocated, it will already have been flushed from the cache.

The resource element may be returned to the queue in either of two ways: to the top of the queue or to the bottom of the queue. If the element is returned to the bottom of the queue, the next element allocated, the top element, will be the least recently used element. Consequently, by the time the element is actually re-allocated, there is a high likelihood that the previous data will no longer be in the cache and, therefore, processing may be slower. However, in the event that a significant error event occurs, the contents of the resource element, as well as that of other elements, are more likely to be intact and available to be reviewed for problem determination. On the other hand, if the resource element is returned to the top of the list, the next allocation will be of the most recently used element; that is, the same element. Consequently, there is a high likelihood that the previous data will still be in the cache and, therefore, processing will be relatively fast. However, the contents of the resource element will have been overwritten and a useful history of freed resource elements will have been lost.

Consequently, a need remains for queue management which allows the retention of data history while minimizing the impact on cache performance.

### SUMMARY OF THE INVENTION

The present invention provides a method, controller, program product and service for more efficiently managing a resource queue. Rather than use a single queue inefficiently sized to handle the largest expected workload, two or more queues are configured to handle workloads of various sizes. For example, the size of a first queue may be selected to provide sufficient resource elements to handle a system's normal workload. Resource elements are allocated from the top of the first queue and returned to the bottom. The size of a second queue may be selected to provide sufficient resource elements to handle the system's increased workload. If the workload increases and all of the resource elements in the first queue are concurrently allocated, new resource elements are allocated from the top of the second queue and returned to the bottom. Additional queues may be configured, each having a size selected to handle increasing workloads. As the resource elements of each queue are depleted, elements in the next queue are allocated. When the workload decreases, resource elements are no longer allocated from the queues used for higher workloads.

Thus, retention of historical data in the queues is enhanced while efficient cache utilization is maintained.

### BRIEF DESCRIPTION OF THE DRAWINGS

FIG. 1 is a block diagram of a queue controller of the present invention;

FIGS. 2A-2E schematically represent the use of resource element queues configured in accordance with the present invention; and

FIG. 3 is a flowchart of a method of queue management of the present invention.

### DETAILED DESCRIPTION OF THE PREFERRED EMBODIMENT

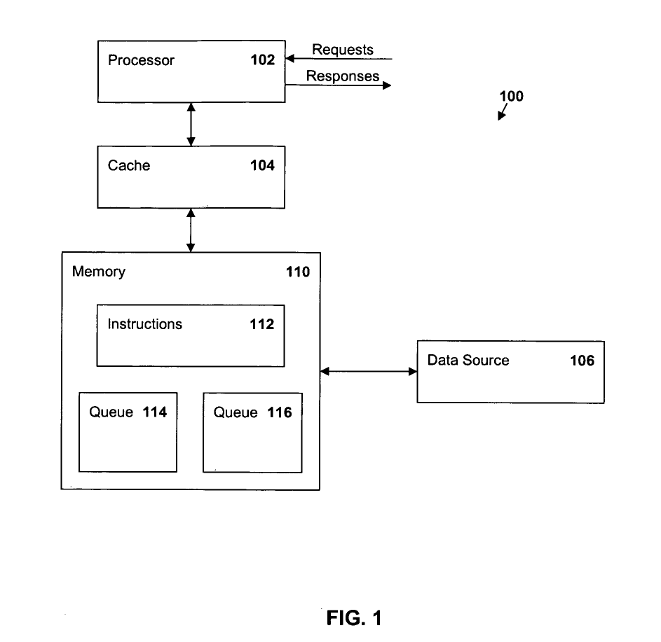

FIG. 1 is a block diagram of a queue control system 100 of the present invention. The controller 100 includes a processor 102 which receives requests and processes requests and transmits responses. The controller 100 further includes a cache 104 for fast access to recently used data and a memory device 110 in which is stored instructions 112 as well as other data retrieved from a data source 106.

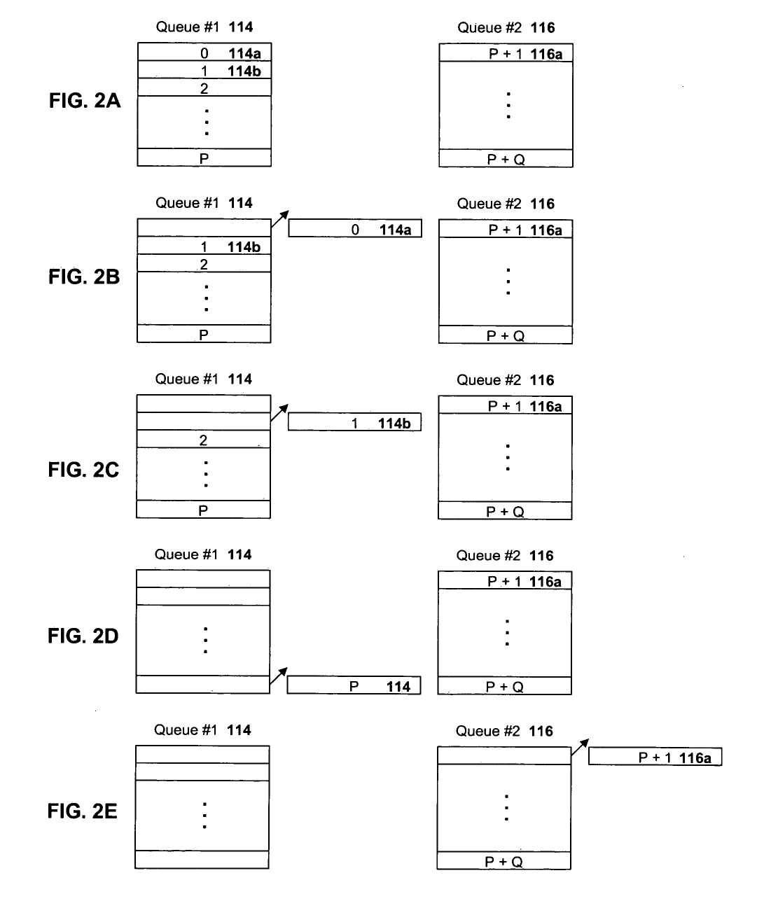

The memory device 110 includes two or more queues 114 and 116 as also illustrated in FIG. 2. Although only two queues are illustrated, the memory device may be configured with additional queues. The number and size of the queues 114 and 116 may be determined based on such factors, among others, as the size of the cache 104, cache utilization under various workloads, the performance characteristics of the memory device 110 and the system performance desired. Moreover, the number and size of the queues 114 and 116 may be statically or dynamically tuned during the operation of the system to optimize performance.

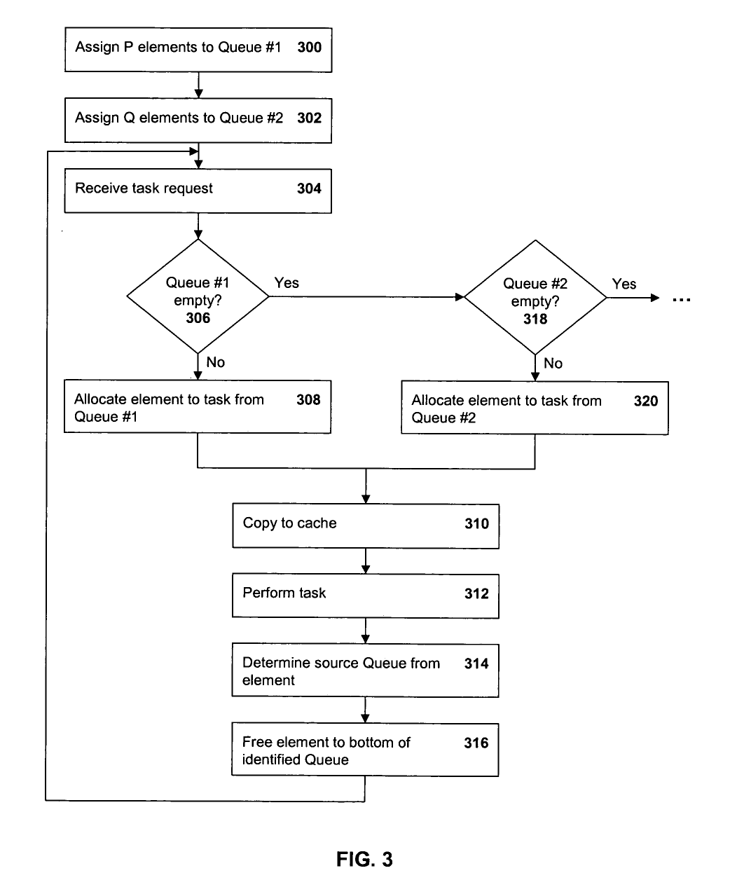

The size of the first queue 114 has been selected to hold P resource elements and the size of the second queue 116 has been selected to hold Q resource elements; the sizes of the queues 114 and 116 are not necessarily the same. Referring to FIGS. 2A-2E and the flowchart of FIG. 3, the queue controller 100 assigns memory space for P resource elements to the first queue 114 (step 300) and assigns memory space 110 for Q resource elements to the second queue 116 (step 302; FIG. 2A). Additional memory space 110 may also be assigned to any additional queues which are established. When a task request is received (step 304), the first queue 114 is examined to determine whether it contains an unallocated resource element (step 306). If so, the top-most resource element 114a is allocated to the task (step 308; FIG. 2B) and data related to the task (including instructions, data structures and data from the data source 106) are copied into the cache 104 if not already present (step 310). The task is then performed (step 312) and the resource element freed to the bottom of the first queue 114 (step 314).

At some time after the first resource element is allocated, another task request may be received (step 304; for clarity, the flowchart of FIG. 3 shows this occurring after the first resource element is freed following completion of the first task; however, the new task request may be received before the previous task is completed). Again, the first queue 114 is examined to determine whether it contains an unallocated resource element (step 306) and, if so, the now top-most resource element 114b is allocated to the task (step 308; FIG. 2C). However, if at any time all P resource elements of the first queue 114 have been allocated (FIG. 2D), as would occur if the workload increases to a new and heavier level, the second queue 116 is examined to determine whether it contains an unallocated resource element (step 318). If so, the top-most resource element 116a is allocated to the task (step 320; FIG. 2E). The process continues (steps 310-316) and, when a new task is received (step 304), the queues are again examined in order to identify the lowest level queue having an unallocated resource element. As indicated by the ellipses in the flowchart, the process may include more than the two illustrated queues 114 and 116.

In order to distinguish among resource elements from different queues and ensure that each element is freed to the correct queue, a field is included in each element identifying the queue from which it was allocated (steps 314-316).

Because resource elements are allocated from the top of each queue and freed to the bottom, the least recently used element is allocated for a new task and the most recently used element is preserved for problem determination. Moreover, under periods of high stress or increased workload, resource elements will be allocated from higher level queues which are not used during periods of low stress or normal workloads. Consequently, the contents of the resource elements is preserved even longer during high workload periods when failures are more likely to occur.

It is important to note that while the present invention has been described in the context of a fully functioning data processing system, those of ordinary skill in the art will appreciated that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to an apparatus, the need in the art may also be met by a method of managing resource element queues, a computer program product containing instructions for managing resource element queues, or a method for deploying computing infrastructure comprising integrating computer readable code into a computing system for managing resource element queues.

What is claimed is:

1. A method for managing resource element queues in a computer system, comprising:
assigning memory resources to at least a first queue of P resource elements and a second queue of Q resource elements, each queue having a top and a bottom;
allocating a first element from the top of the first queue to a first task;
copying first data related to the first task into a cache;
performing the first task;
freeing the first element to the bottom of the first queue upon completion of the first task;
repeating the allocating, copying, retrieving, performing and freeing steps for at least a second task; and
if the number of tasks being performed concurrently equals P:
allocating a P+1st element from the top of the second queue to a P+1st task;
copying P+1st data related to the P+1st task into the cache;
performing the P+1st task; and
freeing the P+1st element to the bottom of the second queue upon completion of the P+1st task.

2. The method of claim 1, further comprising:
allocating a third element from the first queue for a third task if the number of tasks being performed concurrently becomes less than P after at least the P+1st element has been allocated from the second queue;
copying third data related to the third task into the cache;
performing the third task; and
freeing the third element to the bottom of the first queue upon completion of the third task.

3. The method of claim 1, wherein:
assigning memory resources to the first queue comprises substantially matching the amount of memory resources assigned to a first workload level; and
assigning memory resources to the second queue comprises substantially matching the amount of memory resources assigned to the second queue to a second workload level, the second workload level being greater than the first workload level.

4. A queue controller, comprising:
a first queue of P resource elements, the first queue having a top and a bottom;
at least a second queue of Q resource elements, the second queue having a top and a bottom;
means for receiving a task request;
means for allocating a element from the top of the first queue to the first task;
means for copying data related to the task into a cache;
means for freeing the element to the bottom of the first queue upon completion of the task;
means for switching to the second queue if the number of elements allocated concurrently equals P, whereby:
a P+1st element is allocated from the top of the second queue to a P+1st task;
P+1st data related to the P+1st task is copied into the cache; and
the P+1st element is freed to the bottom of the second queue upon completion of the P+1st task.

5. The queue controller of claim 4, wherein the means for switching further comprises means for switching back to the first queue if the number of elements allocated concurrently becomes less than P.

6. The queue controller of claim 4, further comprising:
means for substantially matching the number P elements assigned to the first queue to a first workload level; and
means for substantially matching the number Q elements assigned to the second queue to a second workload level, the second workload level being greater than the first workload level.

7. A computer program product of a computer readable medium usable with a programmable computer, the computer program product having computer-readable code embodied therein for managing resource element queues in a computer system, the computer-readable code comprising instructions for:
assigning memory resources to at least a first queue of P resource elements and a second queue of Q resource elements, each queue having a top and a bottom;
allocating a first element from the top of the first queue to a first task;
copying first data related to the first task into a cache;
performing the first task;
freeing the first element to the bottom of the first queue upon completion of the first task;
repeating the allocating, copying, retrieving, performing and freeing steps for at least a second task; and
if the number of tasks being performed concurrently equals P:
allocating a P+1st element from the top of the second queue to a P+1st task;
copying P+1st data related to the P+1st task into the cache;
performing the P+1st task; and
freeing the P+1st element to the bottom of the second queue upon completion of the P+1st task.

8. The computer program product of claim 7, further comprising instructions for:
allocating a third element from the first queue for a third task if the number of tasks being performed concurrently becomes less than P after at least the P+1st element has been allocated from the second queue;
copying third data related to the third task into the cache;
performing the third task; and
freeing the third element to the bottom of the first queue upon completion of the third task.

9. The computer program product of claim 7, wherein:
the instructions for assigning memory resources to the first queue comprise instructions for substantially matching the amount of memory resources assigned to a first workload level; and
the instructions for assigning memory resources to the second queue comprise instructions for substantially matching the amount of memory resources assigned to the second queue to a second workload level, the second workload level being greater than the first workload level.

10. A method for deploying computing infrastructure, comprising integrating computer readable code into a computing system, wherein the code in combination with the computing system is capable of performing the following:
assigning memory resources to at least a first queue of P resource elements and a second queue of Q resource elements, each queue having a top and a bottom;
allocating a first element from the top of the first queue to a first task;
copying first data related to the first task into a cache;
performing the first task;
freeing the first element to the bottom of the first queue upon completion of the first task;
repeating the allocating, copying, retrieving, performing and freeing steps for at least a second task; and
if the number of tasks being performed concurrently equals P:
allocating a P+1st element from the top of the second queue to a P+1st task;
copying P+1st data related to the P+1st task into the cache;
performing the P+1st task; and
freeing the P+1st element to the bottom of the second queue upon completion of the P+1st task.

11. The method of claim 10, wherein the code in combination with the computing system is further capable of performing the following:
allocating a third element from the first queue for a third task if the number of tasks being performed concurrently becomes less than P after at least the P+1st element has been allocated from the second queue;
copying third data related to the third task into the cache;
performing the third task; and
freeing the third element to the bottom of the first queue upon completion of the third task.

12. The method of claim 10, wherein:
the amount of memory resources assigned to the first queue is substantially matched to a first workload level; and
the amount of memory resources assigned to the second queue is substantially matched to a second workload level, the second workload level being greater than the first workload level.
